(19) United States
(12) Patent Application Publication
(10) Pub. No.: US 2005/0219854 A1
(43) Pub. Date: Oct. 6, 2005

(54) Illuminated grab handle assembly wih integrated control features

(76) Inventor: John E. Grady, Lombard, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/813,583

(22) Filed: Mar. 30, 2004

(51) Int. Cl. B60Q 1/00

(52) U.S. Cl. 362/490; 362/545; 362/501

(57) ABSTRACT

An illuminated grab handle assembly for mounting to a surface is provided. The grab handle assembly includes a handle member and a base assembly receiving an end of the handle member and adapted to be mounted to the surface. An illumination source positioned between the base assembly and the handle is also included for illuminating the handle member. A solar cell is mounted to the base assembly for generating an electric current in response to the detection of an ambient light. A rechargeable battery is mounted to the base assembly and is electrically connected to both the illumination source and the solar cell wherein the electric current generated by the solar cell charges the rechargeable battery. A photoelectric cell for detecting an ambient light and generating an output signal corresponding to the detected ambient light is provided. A switch is also provided for receiving the output signal, the switch being operably connected to the illumination source, the switch adapted to open and close an electrical connection between the illumination source and the power source, wherein the switch opens and closes in response to the output signal received from the photoelectric cell.

### TECHNICAL FIELD

This invention relates generally to illuminated grab handle assemblies that may be attached to any of several surfaces. Particularly, it relates to an illuminated grab handle assembly with various control and power features.

### BACKGROUND OF THE INVENTION

Grab handles, illuminated and otherwise are well-known in the art. Among the illuminated handles disclosed in the prior art are those disclosed in U.S. patents include U.S. Pat. No. 5,297,010 (“the '010 patent”) and U.S. Pat. No. 5,025,352 (“the '352 patent”). While both of these illuminated handles are generally satisfactory for their intended purposes, they are not aesthetically pleasing because their means of connection, such as screws, are exposed when those handles are secured to a surface. For example, the '010 patent discloses a pair of screws that secure the handle to a surface. This is evidenced from column 3, lines 50-53, of the '010 patent: “(h)eads of the screws 18 are exposed through the exterior surface 10 of the member 1 for access by a tightening or loosening tool . . . ” The use of the term “illuminated grab handle” to describe this invention is also somewhat misleading, in that the handle itself is apparently not illuminated. Instead, as indicated at column 3, lines 14-22, the light merely illuminates the wall behind the handle: “light from the light bulb . . . splashes on the vehicle wall W behind the grab handle 100.” All that is seen is the splash of light emanating from behind the handle when the power is turned on. The splash of light extends laterally beyond the sides of the handle along the wall W. In this manner, the user can see the handle 100 at night by the light reflected from the wall W.”

The '352 patent is directed to a lighted grab handle for trucks. The grab handle itself is apparently illuminated, but its mounting means, preferably screws or bolts, are highly visible when the grab handle is in use. See FIGS. 2 and 3 and column 2, lines 47-50 of the '352 patent, and see especially the visible bolts 30 in those two FIGURES.

Other generally relevant patents include U.S. Pat. Nos. 4,414,611; 5,528,468; 5,746,498; and 6,079,859 (referred to as “the '611, the '468, the '498, and the '859 patent”, respectively). The '611 patent is directed to a portable light having a housing which can be mounted onto a support surface. The device in the '611 patent includes a main housing section, a removable back, and a removable upper transparent cover. The housing has a stepped construction. This device is not, however, an illuminated handle.

The '468 patent is directed to an opera light for mounting upon either the “B” or “C” pillars of an automobile. The opera light of this invention is thin and flat, and thus cannot be grasped by the user to assist that user in entering or leaving a motor vehicle. Accordingly, this opera light cannot be fairly characterized as a grab handle.

Similarly, neither the '498 nor the '859 patents are directed to grab handles, but are instead directed to other kinds of automotive lamp assemblies. The '498 patent is directed to an auxiliary or third brake lamp, such as the center high mounted stop lamps (CHMSL) that have been mandated in cars sold in the United States since 1985. These CHMSLs may be installed inside of the car, such as upon the parcel shelf behind the rear seat and near the base of the rear window. Alternatively, the CHMSL may be mounted adjacent the top of the rear window, or upon the exterior surface of the car, near the trunk lid and directly in front of the rear window. The '859 patent is directed to an interior lamp assembly for an automobile, such as the assemblies used for interior roof mounted dome lights or side mounted interior reading lights.

Additionally, grab handles are known of a type that include a handle member secured to a pair of mounting assemblies. Each mounting assembly includes a base and a cap. Typically the base is mounted to a surface and the cap is press-fit mounted to the base. Tabs in the cap are received in apertures in the base. This is generally adequate. However, depending on the environment in which the grab handle is used, the cap may unintentionally become removed from the base due to thermal contraction and expansion, vibration or other environmental concerns.

Additionally, illuminated grab handle assemblies are typically powered by a remote power source such as the battery or electrical system of a boat or other vehicle or structure. The grab handle assemblies typically remain lit so long as the electrical system is energized, regardless of whether the ambient light conditions actually require them to be lit. That is, if it is very light in the area immediately surrounding a grab handle assembly, during perhaps a sunny day, it is not particularly necessary to have that assembly illuminated. In this situation, the illuminated grab handle assembly acts as an unnecessary drain or draw on the power source or system to which it is attached.

The present invention is provided to solve these and other concerns.

### SUMMARY OF THE INVENTION

An illuminated grab handle assembly for mounting to a surface and for use with a power source is proved. The grab handle assembly includes a handle member, a mount assembly receiving an end of the handle member and adapted to be mounted to the surface and an illumination source positioned between the mount assembly and the handle for illuminating the handle member, the illumination source adapted to be electrically connected to the power source. A light sensor is also provided for detecting an ambient light and generating an output signal corresponding to the detected ambient light, a switch for receiving the output signal and operably connected to the illumination source, the switch being adapted to open an close the electrical connection between the illumination source and power source. The switch opens and closes in response to the output signal received from the light sensor.

According to another aspect of the invention, the switch is integrally formed with the light sensor.

According to another aspect of the invention, the light sensor is connected to the mount assembly and has a light sensitive surface exposed to the ambient light.

According to another aspect of the invention, the mount assembly includes a base and an overcap removably attached to the base for enclosing the illumination source within the base assembly.

According to another aspect of the invention, the light sensor is connected to the overcap.

According to another aspect of the invention, the light sensor is connected to the base.

### BRIEF DESCRIPTION OF THE DRAWINGS

FIG. 1 is a perspective view of one preferred embodiment of the assembly of the invention, with an opaque overcap on the right side of the assembly shown in exploded view away from its base, and with the overcap on the left side of the assembly positioned to cover the base and the mounting means for the base portion;

FIG. 2 is a top view of the entire assembly of FIG. 1, but with the overcap on the right side of the assembly removed;

FIG. 3 is a side view of the assembly of FIGS. 1 and 2;

FIG. 4 is a cross-sectional, enlarged view of a portion of the right side of the assembly of FIG. 1, showing details of the base portion, and showing the assembly, with the cap in position, being illuminated by an incandescent light bulb or lamp;

FIG. 5 is a side view of the generally curved handle of FIG. 1;

FIG. 6 is an end view, taken along lines 6-6 of FIG. 5, of the generally curved handle of FIG. 5;

FIG. 7 is an exploded perspective view of a mounting assembly of the present invention;

FIG. 8 is a partial cross-section of a side view of the mounting assembly of FIG. 7;

FIG. 9 is a bottom view of a base of the mounting assembly of FIG. 7;

FIG. 10 is a top cross sectional view of the mounting assembly showing the slide lock assembly in its locked position;

FIG. 11 is a top cross sectional view of the mounting assembly showing the slide lock assembly in its unlocked position;

FIG. 12 is a perspective view of a portion of an additional embodiment of the present invention including a light sensor;

FIG. 13 is a sectional view of the additional embodiment of the invention depicted in FIG. 12;

FIG. 14 is a perspective view of a portion of yet an additional embodiment of the present invention including a solar panel;

FIG. 15 is a sectional view of the embodiment of the invention depicted in FIG. 14;

FIG. 16 is a perspective view of a portion of yet an additional embodiment of the present invention including an integral and replaceable power source; and

FIG. 17 is a sectional view of the embodiment of the invention depicted in FIG. 16.

### DETAILED DESCRIPTION

This invention is susceptible of embodiment in many different forms. The drawings show and the specification describes in detail a preferred embodiment of the invention. It will be understood that the present disclosure is to be considered as an example of the principles of the invention. The disclosure is not intended to limit the broad aspect of the invention to the illustrated and described embodiments.

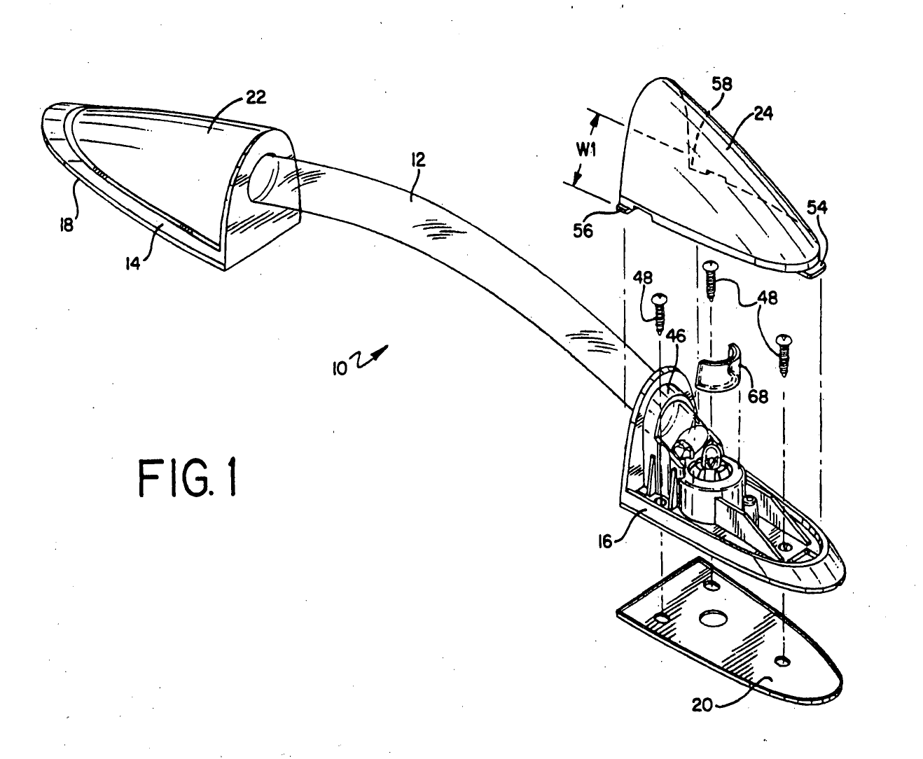

FIG. 1 shows a perspective view of one preferred embodiment of the invention. An illuminated grab handle assembly 10 is shown. The illuminated grab handle assembly 10 shown in this FIG. 1 is simple in its construction, comprising only seven main parts, plus the fasteners to secure the assembly to a mounting surface. The seven main parts include a generally curved handle 12; a pair of mirror image base portions 14 and 16; a pair of mirror image gaskets 18 and 20 that are placed between the base portions 14 and 16 and the surface to which the handle assembly 10 is to be mounted and secured; and a pair of mirror image caps or overcaps 22 and 24 that are secured to the respective base portions 14 and 16.

Referring to FIGS. 1-4, the handle member or generally curved handle 12 is a clear, acrylic rod. It has a diameter of approximately one (1) inch, but may be of any suitable diameter or cross section. The curved handle 12 has a linear length L1, along a center line through the middle (see FIG. 5) of the handle, of approximately 11.75 inches. Of course, L1 may be of any suitable length. The radius R of curvature of this center line is approximately 17.50 inches. The radius of curvature may vary, depending upon the length of the generally curved handle 12. Instead, the handle could be substantially straight, with radiused ends. Furthermore, it is understood that the handle need not be curved at all and remain within the scope of the invention.

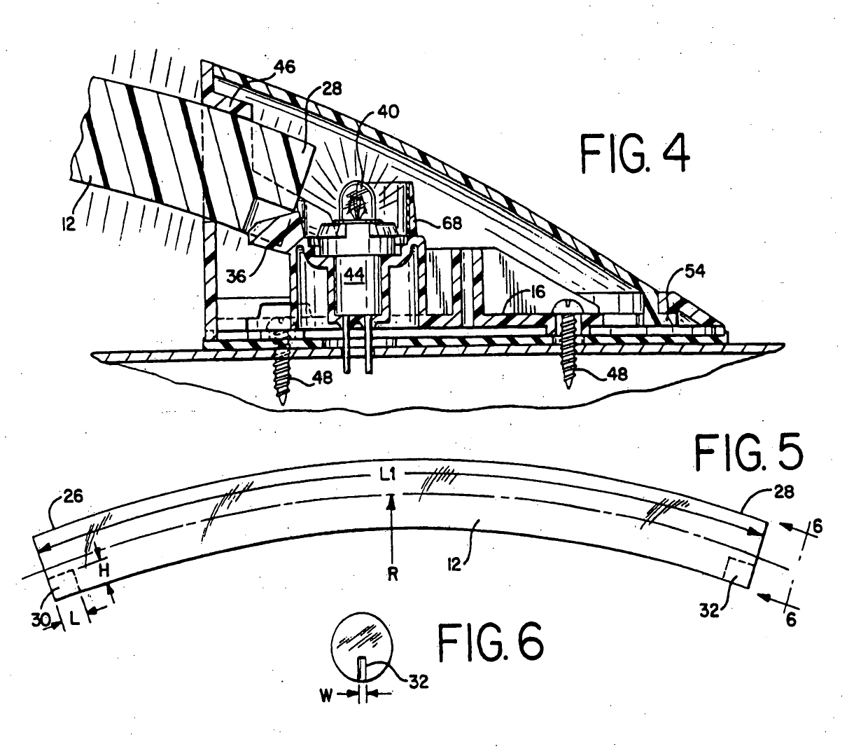

FIG. 4 shows a cross-sectional view of the right side of the illuminated grab handle assembly. It should be understood that the left side of the illuminated grab handle assembly is a mirror image of the structure shown in FIG. 4, and is otherwise identical.

As may best be seen in FIG. 5, the generally curved handle 12 has a pair of ends 26 and 28. The portion of the generally curved handle 12 between the pair of ends 26 and 28 is both solid, as may be seen in FIG. 6, and has a generally cylindrical cross section. As noted, the handle may have any of a variety of cross sections and remain within the scope of the invention. Alternatively, the generally curved handle 12 may be tubular, and made of an acrylic material. As may be seen in FIGS. 5 and 6, each of ends 26 and 28 of the generally curved handle 12 include a groove 30 and 32. In this embodiment, each of these grooves 30 and 32 has a height H of 0.350 inch, a length L2 of 0.375 inch, and a width W of 0.125 inches. As may best be seen in FIGS. 4 and 6, the grooves 30 and 32 are engaged with a keyway 34 (not shown) and 36 in respective base portions 14 and 16. The interfering engagement of the grooves 30 and 32 with the keyways 34 (not shown) and 36, respectively, ensures that the generally curved handle 12 is retained in a non-rotational and stable manner by the base portions 14 and 16. As the handle 12 and its grooves 30 and 32 are moved further onto the respective keyways 34 (not shown) and 36, additional interference creates a tighter fit between the handle 12 and the base portions 14 and 16. In addition, the movement of the grooves at the end of the handle 12 onto the keyways 34 (not shown) and 36 results in a tighter engagement between the top of the handle 12 and the bottom of the top of the sleeve 46, as can best be seen at the top of FIG. 4. This tighter engagement between the handle and the sleeve 46 also helps to inhibit rotation of the handle 12. An illumination source is positioned remotely from the generally curved handle 12. This illumination source projects light through the handle 12. As depicted by projecting lines in FIG. 4, the illumination source provides the generally curved handle 12 itself with a substantially uniform, fully illuminated appearance. In other words, the illumination source provides the curved handle 12 with the appearance of a solid bar of light. This contrasts with at least one of the illuminated grab handles of the prior art, as described above, which projects light onto a wall behind the handle.

Preferably, the light is directed towards the handle 12, in order to prevent the unwanted dispersion of light away from that handle 12. Unwanted dispersion of light away from the handle 12 results in a less brightly illuminated handle 12. In order to concentrate the light towards the handle 12, a reflector 68 is provided. This reflector 68 is made of a fire retardant polypropylene having a white matte finish. The reflector 68 has an adhesive backing, permitting the reflector 68 to be adhered to the socket base that surrounds the bulb 40 and its holder. The use of this reflector 68 increases the light intensity in the handle 12 by an estimated 35%, as compared to an apparatus without the reflector 68. In FIG. 1, this reflector 68 is shown exploded upwardly away from the socket base that surrounds the bulb 40 and its holder.

While the assembly 10 must have at least one base portion, as noted above, the present embodiment includes two base portions 14 and 16. These two base portions 14 and 16 accommodate the two illumination sources, here two incandescent lamps 38 or LEDs (not shown) and 40, and a pair of conventional bulb or lamp sockets 42 (not shown) and 44. The bulbs 38 and 40 may be powered by either alternating current, direct current, through a hard-wired circuit, or by battery power. It is also understood that the invention may include, as an illumination source, one or more light-emitting diodes (LEDs).

As may be seen in FIG. 4, end 28 of generally curved handle 12 is secured to base portion 16. As shown in FIG. 1, a sleeve 46 is part of the molded base portion 16. The sleeve 46 has an inner diameter that is slightly larger than the one (1) inch diameter of the generally curved handle 12 and its end 28. The end 28 slides into the sleeve 46 and, as noted above, has a groove 32 that interlocks with the keyway 36.

Mounting means are provided for securing the base portions 14 and 16 to a mounting surface 50. Preferably, the mounting means comprises one or more sets of screws 48.

Opaque colored or translucent overcaps 22 and 24 cover the base portions 14 and 16. These overcaps 22 and 24 obscure the screws 48 or any other mounting means that secure the base portions 14 and 16 to the mounting surface. These overcaps 22 and 24 are preferably made of a grey acrylobutyl styrene (ABS). These unfinished ABS overcaps 22 and 24 may be plated or vacuum metallized with a thin chromium or gold plating.

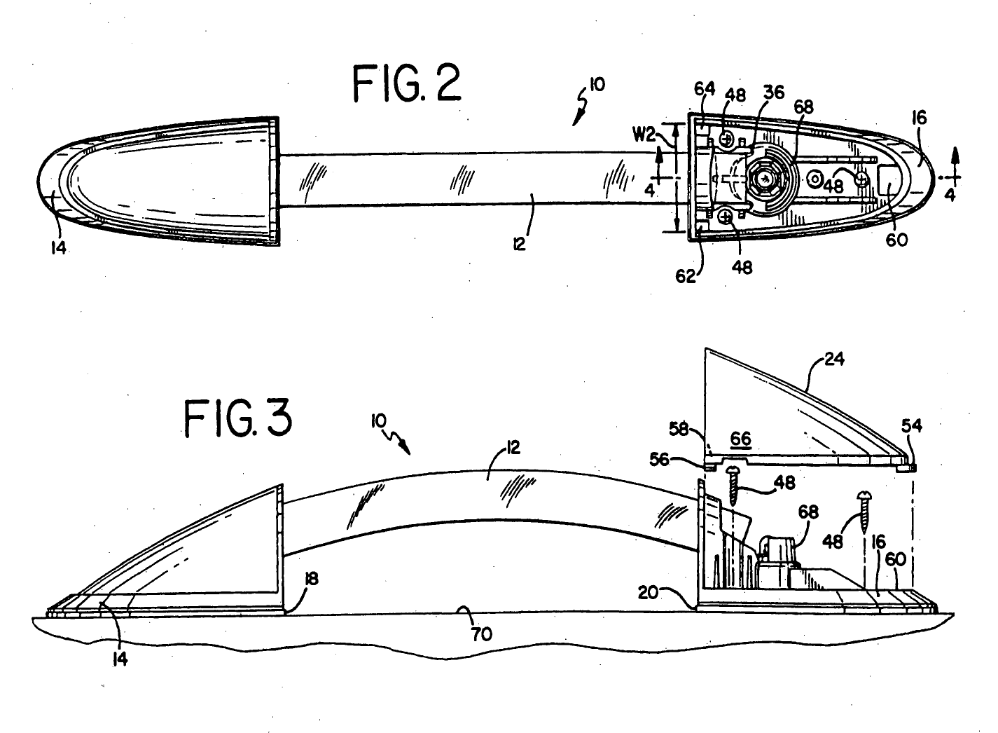

As may best be seen in FIGS. 2, 3 and 4, overcap 24 includes at least one tab. In this embodiment, the overcap 24 includes three tabs 54, 56, and 58. The front tab 54 is secured to a corresponding orifice 60 at the tip of the base portion 16. The two side tabs 56 and 58 (not shown) become secured to orifices 62 and 64 at the sides of the base portion 16.

The overcap 24 has a bottom portion 66, and the width W1 of the bottom portion 66 (depicted in FIG. 1), including the tabs, of the overcap 24 is wider than the width W2 (FIG. 2) of the base portion 16. As a result of this construction, the overcap 24 may be press fit or snap fit onto the base portion 16. Particularly, in order to place the overcap 24 onto the base portion 16, the user grips the bottom portion 66 of the overcap 24 directly above tabs 56 and 58, respectively. The overcap 24 is squeezed inwardly to effectively compress and thereby reduce the width W1 of the back end of the overcap 24. The front tab 54 is then angled into engagement with its corresponding orifice 60. While maintaining squeezing pressure upon the back end of the overcap 24, tabs 56 and 58 are lowered towards their corresponding orifices 62 and 64. When the tabs 56 and 58 are positioned adjacent the orifices 62 and 64, the pressure imposed upon the overcap 24 by the thumb and forefinger is released. The tabs 56 and 58 then spring into a locking engagement with orifices 62 and 64. Removal of the overcap 24 from the base portion 16 is the reverse of installation.

The overcap 24 may be removed to gain access to and permit replacement of the incandescent lamp or LED 40. If the bulbs 38 and 40 are powered by batteries rather than direct or alternating current, these batteries may be placed below the overcap 24. Access to the batteries is obtained by removal of the overcap 24.

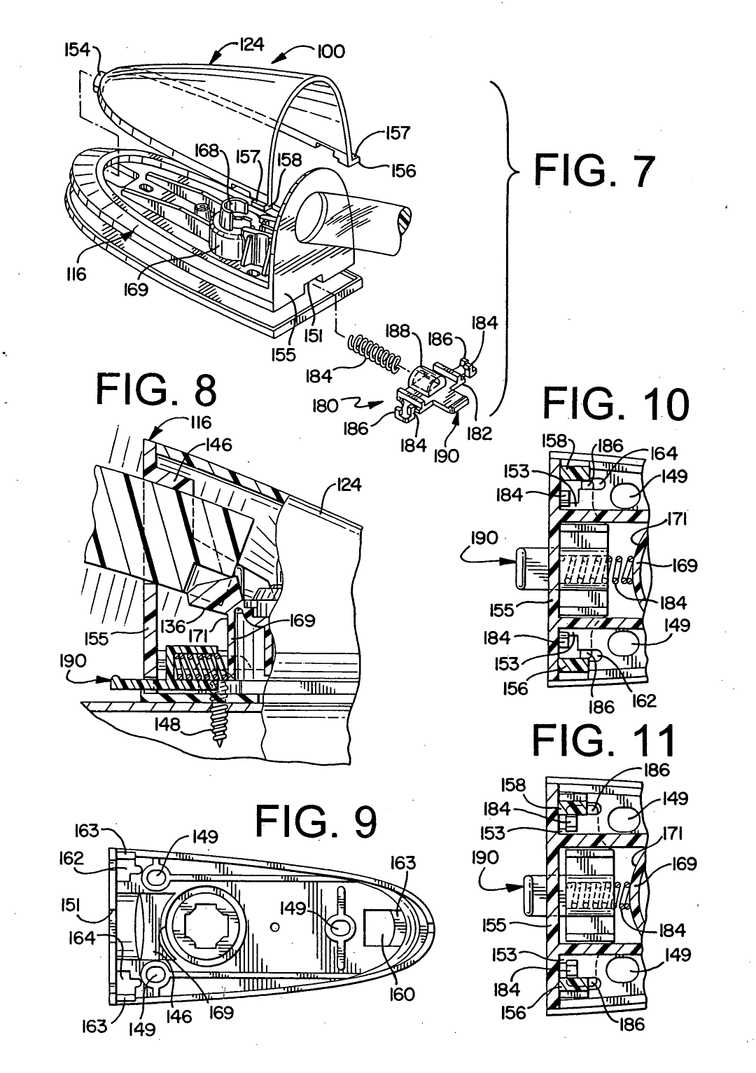

The bases or base portions 14, 16 and cap or overcaps 22-24 together comprise a mounting assembly. FIGS. 7-11 disclose an alternative preferred embodiment of a mounting assembly 100 for an illuminated grab handle assembly 10. It is noted that the mounting assembly 100 of the present invention may be utilized with other than illuminated grab handle assemblies while remaining within the scope of the below claims.

The mounting assembly 100 is comprised of a base or base portion 116, a cap or overcap 124, and a slide lock assembly 180.

The base 116 is nearly identical to the base 16 disclosed and described above. Accordingly, features of the base 116 that are similar to described features of the base 16, are referred to by the same number, plus 100. Where differences exist, such differences are noted. Accordingly, the base 116 includes a keyway 136, a sleeve 146 and a reflector 168, similar in form and function to those described above. The base 116 also includes a socket base 169 adapted for mounting an illumination source such as the incandescent lamp 40 described above. However, it is noted again that use of an illumination source is not required. The base 116 also includes mounting means comprising screws 148 and screw holes 149. Other mounting means may be utilized such as rivets or other connectors. Additionally, any appropriate adhesive may also be utilized. Similar to the base 16, the base 116 includes front or fore orifice or aperture 160 and side orifices or apertures 162 & 164. Each aperture 162, 164 defines an aperture-locking surface 163.

The base 116 further includes a button slot 151 and a pair of rails 153. The button slot 151 is located on and extending through a front face 155 of the base 116. Each rail 153 is proximal to and defines in part a respective side aperture 162, 164.

The cap 124 of the embodiment depicted in FIGS. 7-11 is identical in all respects to the cap depicted in FIGS. 1-6 and described above. Accordingly, the cap 124 includes a front tab 154 and a pair of side tabs 156 & 158. The cap 124 also has a width W1 including side tabs 156 & 158. Additionally, each tab 156, 158 defines a tab-locking surface 157.

The slide lock assembly 180 includes a slide member 182 and a spring 184. The slide member 182 includes a pair fingers 184, a pair of protrusions or pins 186, a spring seat 188 and an actuator or button 190. The slide member 182 is generally flat. A single finger 184 extends from the slide member 182 at each of opposed sides of the slide member 182. A single pin 186 extends from the slide member 182 at each of opposed sides of the slide member 182.

The button 190 and seat 188 are generally opposed to one another. The seat 188 is a generally cylindrical receptacle. The spring 184 mounts to the slide member 182 by insertion of the spring 184 into the seat 188. The seat may take other forms, such as a spring post (not shown) about which a spring 184 may be mounted. The spring 184 depicted in FIGS. 7-11 is a generally helical compression spring. Of course, other biasing means may be used including leaf springs, torsional springs, or any resiliently flexible member. A resiliently flexible member integral to either the slide member 182 or the base 116 may be used.

The slide member 182 is slidingly mounted to the base 116 such that the fingers 184 are disposed within a respective side aperture 162, 164 to engage and slide along a respective rail 153. When assembled, the pins 186 are disposed within respective side apertures 162, 164. The spring 184 is received at one end by the seat 188. Another end of the spring 184 abuts against an exterior surface 171 of the socket base 169.

Assembly of the cap 124 to the base 116 is very similar to that described above with respect to cap 24 and base 16. The front tab 154 of the cap 124 is angled and inserted into the fore aperture 160. The portions of the cap 124 just above each side tab 156 & 158 are compressed as the side tabs 156 & 158 are moved towards their respective side apertures 162 & 164. As the tabs 156 & 157 are inserted into apertures 162 & 164, the button 190 is depressed. Depressing the button 190 moves the pins 186 from the locked position shown in FIG. 10 to an unlocked position, as shown in FIG. 11. Once the tabs 156, 158 are fully within respective apertures 162, 164, the cap 124 is released by the user causing the tabs 156, 158 to move laterally to a fully installed position. That is, the tab locking surfaces 157 are in interfering relation to the aperture locking surfaces 163. The button 190 is then released wherein the spring 184 slides the slide member 182 to the locked position. It can be seen that in the locked position, the pins 186 are immediately adjacent the tabs 156, 158. In this position, the pins 186 prevent the tabs 156, 158 from compressing or moving in a direction wherein the tab locking surfaces 157 will disengage the aperture locking surfaces 163. The pins 186 thus maintain the tabs 156, 158 within their respective apertures 162, 164. This effectively locks or secures the cap 124 to the base 116 against any unintended or otherwise accidental separation of the cap 124 from the base 116.

To remove the cap 124 from the base 116, the opposite procedure is used. The button 190 is depressed thus disengaging the pins 186 from their respective tabs 156, 158. The cap 124 is then compressed, thereby causing the tab locking surfaces 157 to disengage respective apertures locking surfaces 163 The cap 124 may then be lifted away from the base 116.

It should be noted that no spring or other biasing means need be utilized to remain within the scope of the invention. In an embodiment lacking the biasing means, the slide member 182 and base 116 may be adapted to hold the slide member 182 in the locked position. For instance, the rail or rails 153, may include a bump positioned to interfere with the finger(s) 184 to releasably hold the slide member 182 in the locked position.

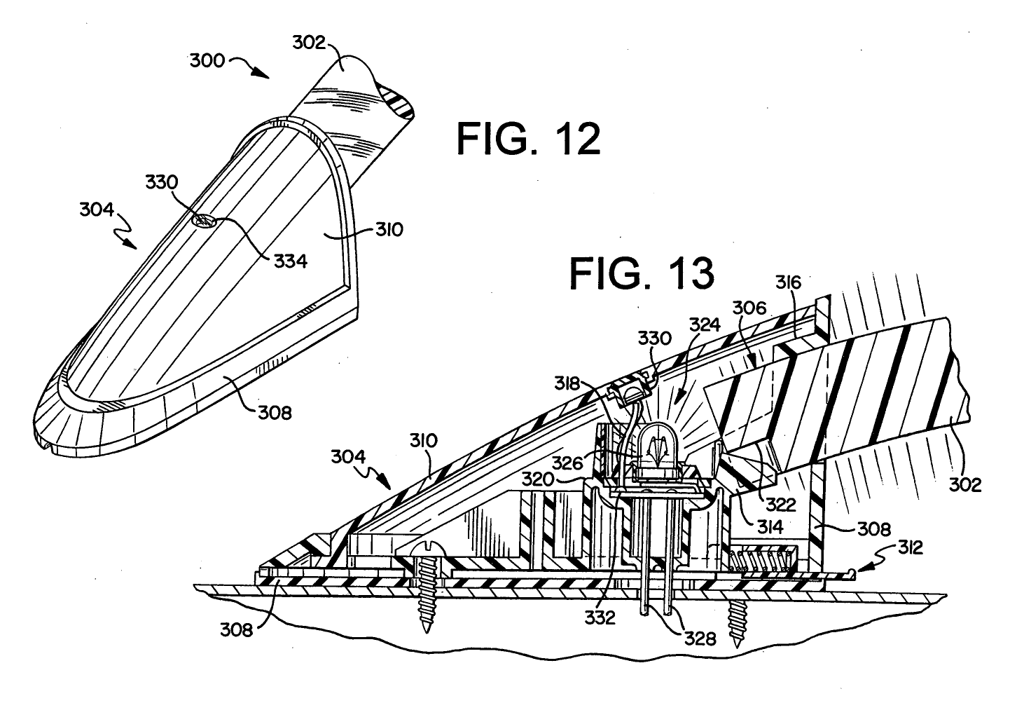

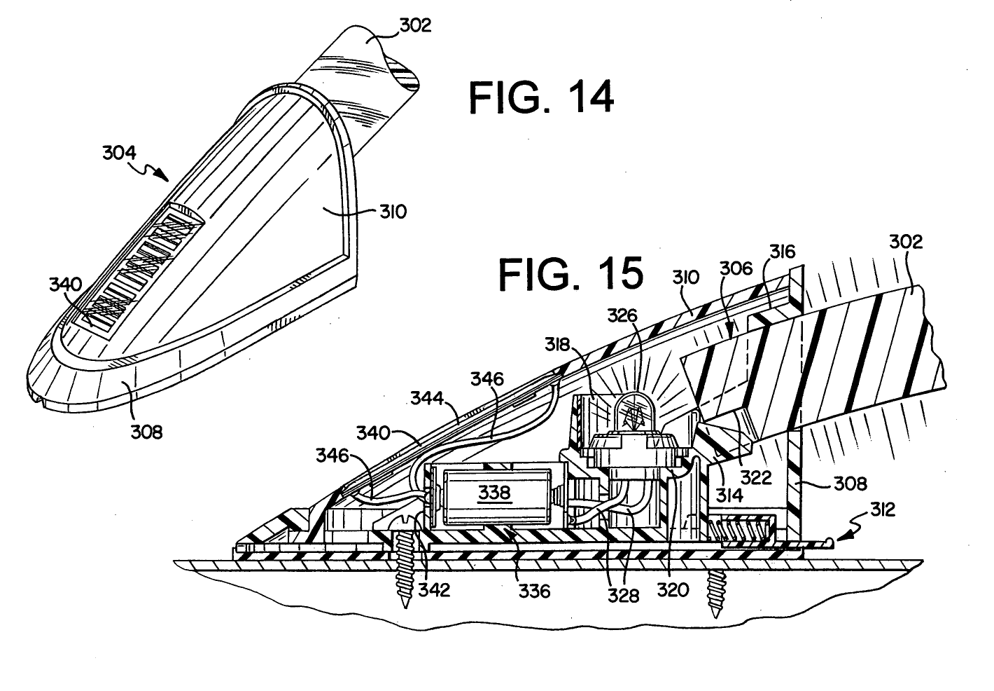

FIGS. 12 and 13 show an additional embodiment of the illuminated grab handle assembly 300 of the present invention. The assembly 300 of FIGS. 14 and 15 include a handle 302 and a pair of mounting assemblies 304. Because each mount assembly 304 is essentially identical, only one mount assembly 304 is shown in the FIGS.

The handle 302 depicted is similar to the previously described handle and is comprised of a clear acrylic rod. Other materials may be used provided they are adapted for transmitting light along their length and permit said light to be diffused through an intermediate surface area. The handle 302 has a pair of ends 306, each end 306 adapted to be received by a base assembly 304.

Each mount assembly 304 includes a base or base portion 308, a cap 310 and a slide lock assembly 312. The base 308 is nearly identical to the base 116 previously described. Accordingly, the base 304 includes a keyway 314, a sleeve 316, a reflector 318 and a socket base 320 for mounting an illumination source 324 between the handle 302 and the mount assembly 304.

The keyway 314 is adapted to be received by a groove 322 in the handle end 306. The sleeve 316 is adapted to receive an end 306 of the handle 302. The socket base 320 is adapted for mounting the illumination source 324 thereto. The reflector 318 is adapted to reflect and direct light emitted by the illumination source 324 towards the handle end 306, all as previously described.

The illumination source 324 shown in FIGS. 12 and 13 is an incandescent bulb 326. It is important to note that any known type of illumination source 324 can be utilized provided it may be sized to fit within the mount assembly 300. For instance, one or more high or low intensity light emitting diodes (LED) may be used, as well. This is true for all embodiments described and/or disclosed in this application. A set of electrical connections or leads 328 lead from the incandescent bulb 326 to a power source (not shown).

Also included with the embodiment of FIGS. 12 and 13 is a photoelectric cell or light sensor 330 and a switch 332. The sensor 330 is electrically connected to the switch 332, which in turn, is electrically connected between the power source and the incandescent bulb 326 for opening and closing the electrical connection between the bulb 326 and the power source. The sensor 3330 is snap fit, interferingly fit, or otherwise connected to or mounted to a cap aperture 334 in the overcap 310. The sensor 330 fits within the cap aperture 334 in a manner to seal an interior of the mount assembly 304 from the elements. A gasket or washer may be provided for this purpose. In any event, the sensor 330 is mounted such that it is exposed to ambient light.

The sensor 330 is a photovoltaic type of photoelectric cell comprising a semiconductor crystal with two zones of dissimilar materials. When light shines on the crystal a voltage is set up across the junction between the two zones creating an electrical current. This current is used as an input in the switch 332 which opens and closes in response to the current generated by the sensor 330.

In operation, in the presence of an adequate amount of ambient light, the sensor 330 will generate an electric current. In response, the switch 332 will open, thereby turning off the illuminated grab handle assembly 300. In other words, the switch 332 turns the incandescent bulb 326 off. When the amount of ambient light drops below a predetermined level, such as in the darkness of night, the sensor 330 will cease to produce an electrical current. In response, the switch 332 will close, thereby re-establishing the electrical connection between the bulb 326 and the power source, thereby turning the bulb 326, and the assembly 300, on.

It is noted that any sort of known light sensor may be employed while remaining within the scope of the present invention. Also, the switch or switching function may be integrated or integral to the sensor 330. In this case, the sensor 330 is electrically connected in series between the power source and the bulb. In the presence of a sufficient and predetermined amount of ambient light, the sensor 330 opens the electrical connection between the bulb 326 and the power source. In the absence of a sufficient and predetermined amount of ambient light, the sensor 330 re-establishes or closes the electrical connection between the bulb 326 and the power source.

It is also noted that although only a single mount assembly 304 has been depicted and described in connection with FIGS. 12 and 13, the handle assembly 300 is typically provided with a second mount assembly 304 receiving another handle end 306. The second mount assembly 304 would typically be identical to that described above. However, it is further noted that the handle 302 may be sufficiently lighted by a single illumination source 324. In such case, the second mount assembly 304 may be provided without any illumination source or any means for controlling same. This is true for all embodiments described and disclosed herein.

FIGS. 14 and 15 show an additional preferred embodiment of the present invention. This embodiment is similar to that described in connection with FIGS. 12 and 13, however, it does not include the sensor 330 or switch 332. The embodiment of FIGS. 14 and 15 includes a handle 302 with handle ends 306, mount assembly 304 with base 308 and over cap 310, all very similar to those described immediately above and therefore similarly numbered. Also, the base 308 of this embodiment includes keyway 314, sleeve 316, reflector 318, socket base 320, slide lock assembly 312, and illumination source 324 with bulb 326 and leads 328, all similar to those previously described.

The mount assembly 304 of FIGS. 14 and 15 further includes a rechargeable power source 336 such as rechargeable battery 338 and a solar panel 340. The rechargeable power source 336 includes a battery receptacle 342 integrally formed with the base 308 and the battery 336.

The solar panel 340 is connected to the cap 310 such that it is exposed to ambient light, as shown in the FIGS. The solar panel 340 is also electrically connected to the power source 336 via leads 346. The solar panel 340 comprises a specially constructed silicon crystal diode. When sufficient ambient light strikes its exposed active surface 344, electrons are knocked loose, some of which have sufficient energy to cross the diode junction, thereby creating an electric current. The electric current is transmitted via leads 346 to the rechargeable power source 336 to recharge same.

The illumination source 324 and bulb 326 thereof are connected to the battery 338 via electrical leads 328.

In operation, the illumination source 324 and bulb 326 thereof is energized by the battery 338. During times of sufficient ambient light, the solar panel 340 recharges the battery 338. It should be noted that a switch (not shown) may be electrically connected between the bulb 326 and the battery 338, and electrically connected to the solar panel 340 such that any electric current generated by the solar panel 340 will act as an input to said switch. In response to the generation by the solar panel 340 of such an electrical current, the switch will open the connection between bulb 326 and battery 338, thereby turning the bulb 326 off. In this way, when there is sufficient ambient light to charge the battery 338, the bulb 326 will turn off. This is desirable because if there is sufficient ambient light to charge the battery 338, presumably, there is sufficient ambient light to render the illumination of the grab handle assembly 300 redundant.

Alternatively, a light sensor 330 and switch 332 as previously described in connection with FIGS. 12 and 13 may be incorporated into the embodiment of FIGS. 14 and 15. The sensor 330 and switch 332 would then control the energizing of the bulb 326, separately from the recharging of the battery 338 as controlled and affected by the solar panel 340.

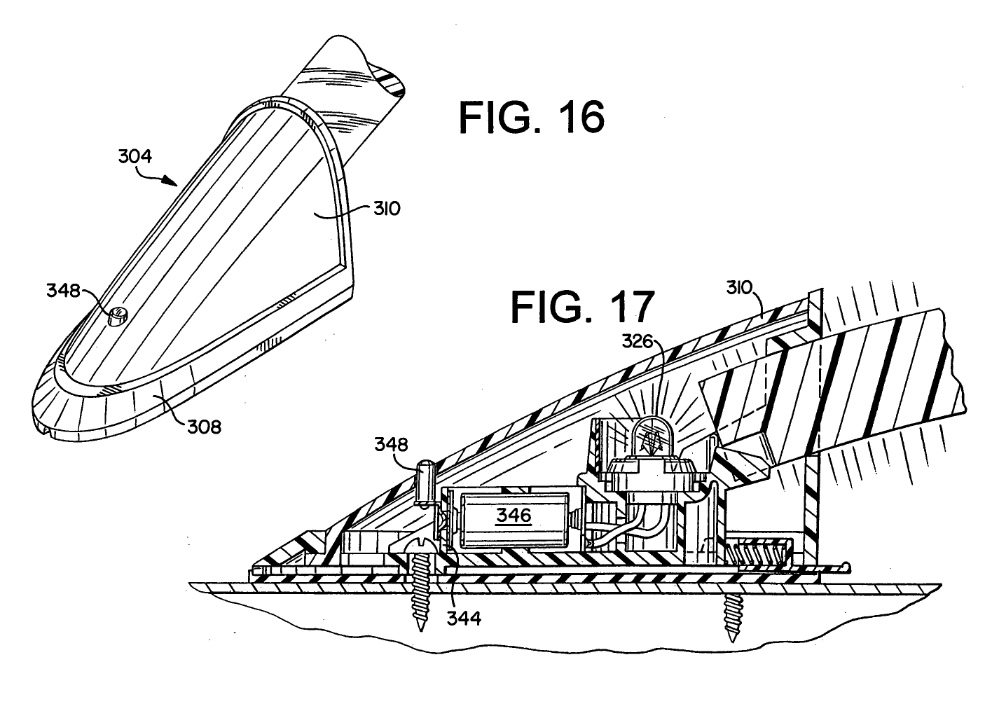

FIGS. 16 and 17 show another preferred embodiment of the present invention. This embodiment is very similar to that of FIGS. 14 and 15. The mount assembly 304 of the present invention includes an integral power source 344 including a standard battery 346 and a manual push button switch 348 having an on and an off position. The incandescent bulb 326 is energized by the battery 346 when the switch 348 is in its on position. When the switch 348 is moved to its off position, it turns the bulb 326 off by opening the electrical connection between the bulb 326 and the battery 346. Because the overcap 310 is easily removable as previously described, the battery 346 is easily replaceable.

Alternatively, the embodiment of FIGS. 16 and 17 could include the sensor 330 and switch 332 combination as described in connection with FIGS. 12 and 13, in place of the push button switch 348.

Specific embodiments have been illustrated and described. Numerous modifications are possible, without significantly departing from the spirit of the invention. Therefore, the scope of protection is only limited by the scope of the accompanying claims.

1. An illuminated grab handle assembly for mounting to a surface and for use with a power source, the grab handle assembly comprising:
a handle member;
a mount assembly receiving an end of the handle member and adapted to be mounted to the surface;
an illumination source positioned between the mount assembly and the handle for illuminating the handle member, the illumination source adapted to be electrically connected to the power source; and
a light sensor for detecting an ambient light and generating an output signal corresponding to the detected ambient light;
a switch for receiving the output signal and operably connected to the illumination source, the switch adapted to open an close the electrical connection between the illumination source and power source;
wherein the switch opens and closes in response to the output signal received from the light sensor.

2. The illuminated grab handle assembly claim 1 wherein the switch is integrally formed with the light sensor.

3. The illuminated grab handle assembly of claim 1 wherein the light sensor is connected to the mount assembly and has a light sensitive surface exposed to the ambient light.

4. The illuminated grab handle assembly of claim 1 wherein the mount assembly includes a base and an overcap removably attached to the base for enclosing the illumination source within the base assembly.

5. The illuminated grab handle assembly of claim 4 wherein the light sensor is connected to the overcap.

6. The illuminated grab handle assembly of claim 4 wherein the light sensor is connected to the base.

7. An illuminated grab handle assembly for mounting to a surface, the grab handle assembly comprising:
a handle member;
a mount assembly receiving an end of the handle member and adapted to be mounted to the surface;
an illumination source positioned between the mount assembly and the handle for illuminating the handle member; and
a power source attached to the mount assembly and electrically connected to the illumination source.

8. The illuminated grab handle assembly of claim 7 wherein the power source comprises a battery.

9. The illuminated grab handle assembly of claim 7 further comprising a switch electrically connected to the illumination source for opening and closing the electrical connection between the illumination source and the power source.

10. The illuminated grab handle assembly of claim 9 wherein the switch comprises a light sensor.

11. The illuminated grab handle assembly of claim 9 wherein the switch is manually operated.

12. The illuminated grab handle assembly of claim 7 wherein the power source comprises a rechargeable battery and the assembly further comprises:
a solar panel mounted to the mount assembly and exposed to ambient light for generating an electrical current, the solar panel electrically connected to the rechargeable battery such that the solar panel is adapted to recharge the battery in the presence of ambient light.

13. An illuminated grab handle assembly for mounting to a surface, the grab handle assembly comprising:
a handle member;
a mount assembly receiving an end of the handle member and adapted to be mounted to the surface;
an illumination source positioned between the mount assembly and the handle for illuminating the handle member; and
a rechargeable battery mounted to the mount assembly and electrically connected to the illumination source for illuminating same;
a switch operably connected to the illumination source for opening and closing the electrical connection between the illumination source and the rechargeable battery;
a solar panel for generating an electric current mounted to the mount assembly and electrically connected to the rechargeable battery for recharging the rechargeable battery.

14. The illuminated grab handle assembly of claim 13 wherein the switch comprises a light sensor.

15. The illuminate grab handle assembly of claim 13 wherein the switch is manually operated.
